(19) United States
(12) Patent Application Publication
(10) Pub. No.: US 2017/0131700 A1
(43) Pub. Date: May 11, 2017

(54) METHOD FOR IMPLEMENTING A NEW REACTIVE SYSTEM

(71) Applicant: Macau University of Science and Technology, Taipa (CN)

(72) Inventors: Zhiwu Li, Taipa (CN); Lei Feng, Taipa (CN); Huimin Zhang, Taipa (CN); Naiqi Wu, Taipa (CN)

(21) Appl. No.: 14/942,031

(22) Filed: Nov. 16, 2015

(30) Foreign Application Priority Data
Nov. 9, 2015 (AU) 2015101642

(51) Int. Cl. G05B 19/10

(52) U.S. Cl. CPC G05B 19/10; G05B 2219/25339

(57) ABSTRACT

A method for implementing a new reactive system and a new reactive system includes applying at least one input suitable for the new reactive system to an existing reactive system to obtain at least one output produced by the existing reactive system; comparing the at least one output with an expected output representative of an output expected to be obtained by applying the at least one input to the new reactive system; determining if the at least one output would be compatible with the expected output; and using the compatibility between the at least one output and the expected output to generate a supervisory control rule set arranged for supervisory control of the existing reactive system when used as part or whole of the new reactive system.

### TECHNICAL FIELD

The present invention relates to a new reactive system and a method for implementing thereof, and particularly, although not exclusively, to reusing an existing reactive system in a new reactive system.

### BACKGROUND

A reactive system is implemented to produce certain outputs or desired responses in response to an input or an event. For example, a computer may be used as a reactive system for calculating a sum of two numbers, in which the two numbers are the inputs and the sum is the output. In an alternative example, a lighting system is a reactive system that may be used to light up one or more lighting elements in response to an actuation of a dimmer in the lighting system.

Different reactive systems may be implemented with different scales and complexities. In some industrial scale reactive systems, the complexity of the system is extremely high and thus may require large amount of effort in the development of such reactive system.

On the other hand, reactive systems are usually specifically designed and implemented. Thus it is generally not possible that an existing reactive system may be used for a new application with different requirements since the input/output for the existing reactive system may not be compatible with the new application.

### SUMMARY OF THE INVENTION

In accordance with the first aspect of the present invention, there is provided a method for implementing a new reactive system comprising the steps of:
applying at least one input suitable for the new reactive system to an existing reactive system to obtain at least one output produced by the existing reactive system;
comparing the at least one output with an expected output representative of an output expected to be obtained by applying the at least one input to the new reactive system;
determining if the at least one output would be compatible with the expected output; and
using the compatibility between the at least one output and the expected output to generate a supervisory control rule set arranged for supervisory control of the existing reactive system when used as part or whole of the new reactive system.

In an embodiment of the first aspect, wherein the supervisory control is arranged to modify a predefined processing pattern of the existing reactive system with the supervisory control rule set to a modified processing pattern for use in the new reactive system.

In an embodiment of the first aspect, wherein the existing reactive system is arranged to process the at least one input to produce the at least one output based on the predefined processing pattern.

In an embodiment of the first aspect, wherein the existing reactive system is a black-box system.

In an embodiment of the first aspect, wherein a modification to the existing reactive system is prohibited.

In an embodiment of the first aspect, the method further comprises the step of indicating at least one incompatible input to the new reactive system whereupon a determination of an incompatibility between the at least one output produced by the existing reactive system and the expected output.

In an embodiment of the first aspect, wherein the supervisory control is arranged to modify the predefined processing pattern to the modified processing pattern whereupon the reactive system receives an incompatible input.

In an embodiment of the first aspect, wherein the supervisory control is arranged to prevent the at least one incompatible input from being processed by the existing reactive system.

In an embodiment of the first aspect, wherein the supervisory control is arranged to prevent an incompatible output from being produced by the new reactive system.

In an embodiment of the first aspect, wherein the supervisory control is arranged to prevent an execution of an instruction being incompatible to the existing reactive system.

In an embodiment of the first aspect, wherein the steps of comparing the at least one output with an expected output representative of an output expected to be obtained by applying the at least one input to the new reactive system and determining if the at least one output would be compatible with the expected output are steps of a learning-based test.

In an embodiment of the first aspect, wherein the learning-based test further comprises the step of receiving at least one requirement associated with the at least one input and the expected output, wherein the at least one requirement is expressed using Propositional Linear Temporal Logic.

In an embodiment of the first aspect, wherein the learning-based test further comprises the step of obtaining a constructed hypothesis model for the existing reactive system.

In an embodiment of the first aspect, wherein the compatibility between the at least one output and the expected output of the new reactive system is represented by a verdicts set arranged to indicate whether the at least one requirement are satisfied.

In an embodiment of the first aspect, the method further comprises the steps of:
repeating the learning-based test against the new reactive system with the supervisory control to determine if at least one new output produced by the new reactive system would be compatible with the expected output; and
modifying the supervisory control rule set based on a compatibility between the at least one new output and the expected output.

In accordance with the second aspect of the present invention, there is provided a new reactive system comprising:
an existing reactive system arranged to produce at least one output in response to at least one input applied to the new reactive system;
a processing module arranged to compare the at least one output with an expected output representative of an output expected to be obtained by applying the at least one input to the new reactive system, and to determine if the at least one output would be compatible with the expected output;
   wherein the compatibility between the at least one output and the expected output is used for generating a supervisory control rule set arranged for supervisory control of the existing reactive system when used as part or whole of the new reactive system.

In an embodiment of the second aspect, wherein the supervisory control is arranged to modify a predefined processing pattern of the existing reactive system with the supervisory control rule set to a modified processing pattern for use in the new reactive system.

In an embodiment of the second aspect, wherein the existing reactive system is arranged to process the at least one input to produce the at least one output based on the predefined processing pattern.

In an embodiment of the second aspect, wherein the existing reactive system is a black-box system.

In an embodiment of the second aspect, wherein a modification to the existing reactive system is prohibited.

In an embodiment of the second aspect, wherein the processing module is further arranged to indicate at least one incompatible input to the new reactive system whereupon a determination of an incompatibility between the at least one output produced by the existing reactive system and the expected output.

In an embodiment of the second aspect, wherein the supervisory control is arranged to modify the predefined processing pattern to the modified processing pattern whereupon the reactive system receives an incompatible input.

In an embodiment of the second aspect, wherein the supervisory control is arranged to prevent the at least one incompatible input from being processed by the existing reactive system.

In an embodiment of the second aspect, wherein the supervisory control is arranged to prevent an incompatible output from being produced by the new reactive system.

In an embodiment of the second aspect, wherein the supervisory control is arranged to prevent an execution of an instruction being incompatible to the existing reactive system.

In an embodiment of the second aspect, wherein the processing module is arranged to employ a learning-based test to the new reactive system so as to determine the compatibility between the at least one output and the expected output.

In an embodiment of the second aspect, wherein the processing module is further arranged to receive at least one requirement associated with the at least one input and the expected output, wherein the at least one requirement is expressed using Propositional Linear Temporal Logic.

In an embodiment of the second aspect, wherein the processing module is further arranged to obtain a constructed hypothesis model for the existing reactive system.

In an embodiment of the second aspect, wherein the compatibility between the at least one output and the expected output of the new reactive system is represented by a verdicts set arranged to indicate whether the at least one requirement are satisfied.

In an embodiment of the second aspect, wherein the processing module is further arranged to repeat learning-based test against the new reactive system with the supervisory control to determine if at least one new output produced by the new reactive system would be compatible with the expected output, wherein the supervisory control rule set is modified based on a compatibility between the at least one new output and the expected output.

### BRIEF DESCRIPTION OF THE DRAWINGS

Embodiments of the present invention will now be described, by way of example, with reference to the accompanying drawings in which:

FIG. 1 is a schematic diagram of a computing server for operation as a new reactive system in accordance with one embodiment of the present invention;

FIG. 2 is a block diagram of an embodiment of a new reactive system in accordance with one embodiment of the present invention;

FIG. 3 is a flow diagram of the method for implementing a new reactive system in accordance with one embodiment of the present invention;

FIG. 4 is a block diagram illustrating an existing reactive system and a wrapper used for the implementation of the new reactive system of FIG. 3;

FIG. 5 is a block diagram showing a supervisory control of a black-box reactive system in the method described in FIG. 3;

FIG. 6 is a state diagram of a constructed automaton model for a new reactive system implemented as a cruise controller;

FIG. 7 is a state diagram of a required automation model H of the new reactive system of the cruise controller of FIG. 6;

FIG. 8 is a state diagram of a controller V₁ of the supervisory control of the new reactive system of the cruise controller of FIG. 6;

FIG. 9 is a state diagram of a constructed hypothesis model G₁ of the supervisory control of the new reactive system of the cruise controller of FIG. 6;

FIG. 10 is a state diagram of a controller V₂ of the supervisory control of the new reactive system of the cruise controller of FIG. 6;

FIG. 11 is a state diagram of a constructed hypothesis model G₂ of the supervisory control of the new reactive system of the cruise controller of FIG. 6;

FIG. 12 is a state diagram of a controller V₃ of the supervisory control of the new reactive system of the cruise controller of FIG. 6;

FIG. 13 is a state diagram of a constructed hypothesis model G₃ of the supervisory control of the new reactive system of the cruise controller of FIG. 6;

FIG. 14 is a state diagram of a controller V₄ of the supervisory control of the new reactive system of the cruise controller of FIG. 6;

FIG. 15 is a state diagram of a constructed hypothesis model G₄ of the supervisory control of the new reactive system of the cruise controller of FIG. 6; and

FIG. 16 is a state diagram of a constructed model for a new reactive system implemented as a brake-by-wire system.

### DETAILED DESCRIPTION OF THE PREFERRED EMBODIMENT

The inventors have, through their own research, trials and experiments, devised that software reuse is an effective approach to addressing software crisis in modern software engineering. Reactive systems perform state-based nonterminating processes that are interrupt-driven and interact with the environment in order to enable, enforce, or prevent certain behaviour in the environment. In real applications of black-box reactive systems, the source code and development models of the reused components are often unavailable, so it is not possible to modify its internals. In many domains, such as dependable systems, component based development is utilized to a lesser degree, since the reused software components must satisfy requirements critically before they are reused to assure the foundational quality. If a component does not satisfy a user requirement, and it can neither be modified either, the developer has to abandon it and develop a new one. The development process cannot enjoy the benefit of software reuse. This research proposes a remedy for the failed components and still enables software reuse.

The control logic of the fault prevention component may be designed by the supervisory control theory of logical discrete-event systems. The theory enforces a plant to follow its requirement behaviour through a closed-loop supervisor. In the theory, a plant is modelled as a finite state automaton. A set of requirements for the plant is also specified as finite state automata. The theory derives methods and tools that can automatically synthesize a maximally permissive supervisor that governs the plant to meet the specifications. The supervisor is maximally permissive since it allows the largest freedom to the plant. However, when a plant is a black-box reactive system, the source code and its logical model is unknown. Supervisory control theory is hence not directly applicable to the black-box system. This paper utilizes an automata learning algorithm to construct a logical model for the black-box reactive system, such that the application domain of supervisory control theory is enlarged.

Automata learning is defined as the process of learning an unknown regular grammar given some additional information. Some classical algorithms are the ID algorithm, the L* algorithm and the RPNI algorithm. These algorithms construct a hypothesis automaton at one-time, while the RPNI2 algorithm, IID algorithm, and IDS algorithm produce hypothesis automaton models incrementally. Automata learning algorithms may be gradually used in software engineering such as formal verification, software testing, model inference and so on. These algorithms are mostly cantered on learning an abstraction model of a complex software system, such that the behaviour of a system can be analysed statistically.

Among these techniques, learning-based testing is a technique for specification-based black-box requirements testing. Learning-based testing may be used to test procedural systems and reactive systems. Combining automata learning algorithms with model checking technology, LBTest is a practical tool for producing high-quality test cases for reactive systems testing. Not only is a set of efficient test cases with high coverage percentage produced by LBTest, but it also iteratively builds hypothesis automata models for the system under test.

Automata learning algorithms combined with supervisory control theory are studied. If the specification is clear but not formalized as an automaton, L* learning algorithm may be used to synthesize a supervisor without the specification model. Queries may be used to an equivalence oracle and an incomplete membership oracle in the L* to learn a minimal deterministic finite automaton consistent with the supremal controllable sublanguage of a known specification language and an unknown plant. An automatic decentralized supervisor synthesis method may be used for an unknown plant using the L* algorithm. However, all these aforementioned methods do not focus on the control for actual black-box systems. The inventors devise that when a plant to be controlled is an executable black-box reactive system without source code and a logical model, supervisory control theory may be applied to enjoy the benefit of software reuse.

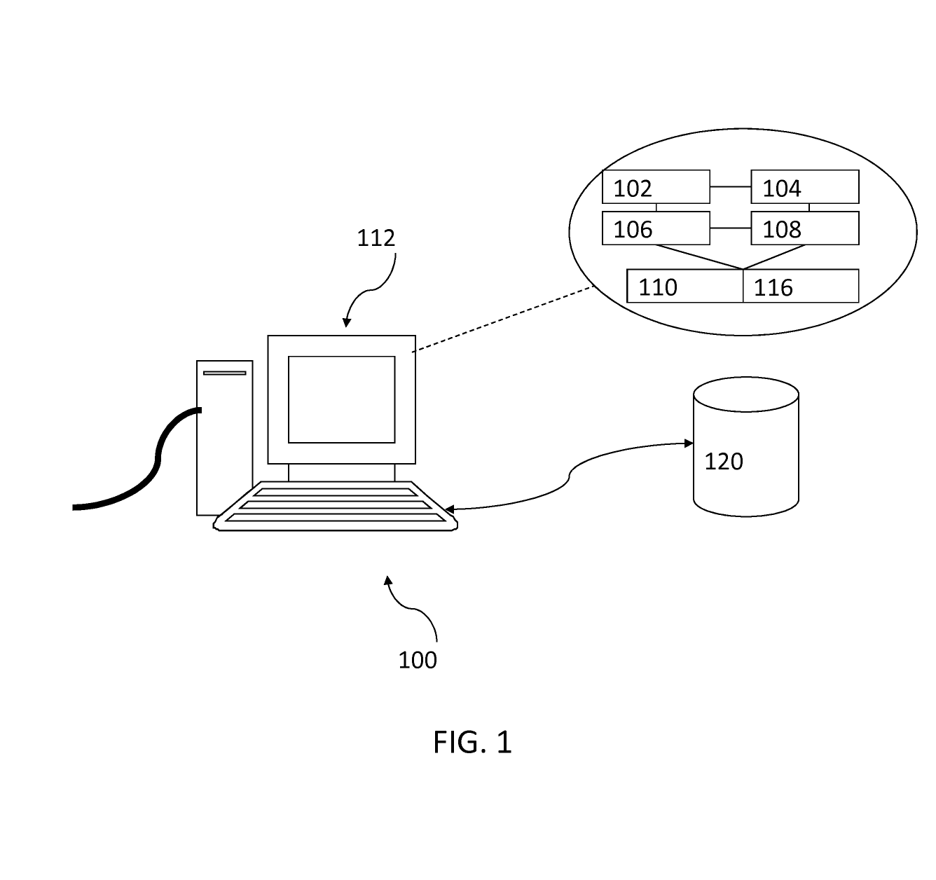

With reference to FIG. 1, an embodiment of the present invention is illustrated. This embodiment is arranged to provide a new reactive system comprising: an existing reactive system arranged to produce at least one output in response to at least one input applied to the new reactive system; a processing module arranged to compare the at least one output with an expected output representative of an output expected to be obtained by applying the at least one input to the new reactive system, and to determining if the at least one output would be compatible with the expected output; wherein the compatibility between the at least one output and the expected output is used for generating a supervisory control rule set arranged for supervisory control of the existing reactive system when used as part or whole of the new reactive system.

In this embodiment, one or more input is applied to the existing reactive system to produce a corresponding output based on a predefined processing pattern of the existing reactive system. The predefined processing pattern is used to govern the transformation of one or more input to one or more output in a fixed and repeatable manner, such that every time the reactive system may produce identical output(s) whereupon receiving corresponding input(s).

In this embodiment, new reactive system, the processing module and the existing reactive system are implemented by or for operation on a computer. The computer may be implemented by any computing architecture, including stand-alone PC, client/server architecture, “dumb” terminal/mainframe architecture, or any other appropriate architecture. The computing device is appropriately programmed to implement the invention.

Referring to FIG. 1, there is a shown a schematic diagram of a computer or a computing server 100 which in this embodiment comprises a server 100 arranged to operate, at least in part if not entirely, the system for authentication in accordance with one embodiment of the invention. The server 100 comprises suitable components necessary to receive, store and execute appropriate computer instructions. The components may include a processing unit 102, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114. The server 100 includes instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices. At least one of a plurality of communications link may be connected to an external computing network through a telephone line or other type of communications link.

The server may include storage devices such as a disk drive 108 which may encompass solid state drives, hard disk drives, optical drives or magnetic tape drives. The server 100 may use a single disk drive or multiple disk drives. The server 100 may also have a suitable operating system 116 which resides on the disk drive or in the ROM of the server 100.

The system has a database 120 residing on a disk or other storage device which is arranged to store at least one record 122. The database 120 is in communication with the server 100 with an interface, which is implemented by computer software residing on the server 100. Alternatively, the database 120 may also be implemented as a stand-alone database system in communication with the server 100 via an external computing network, or other types of communication links.

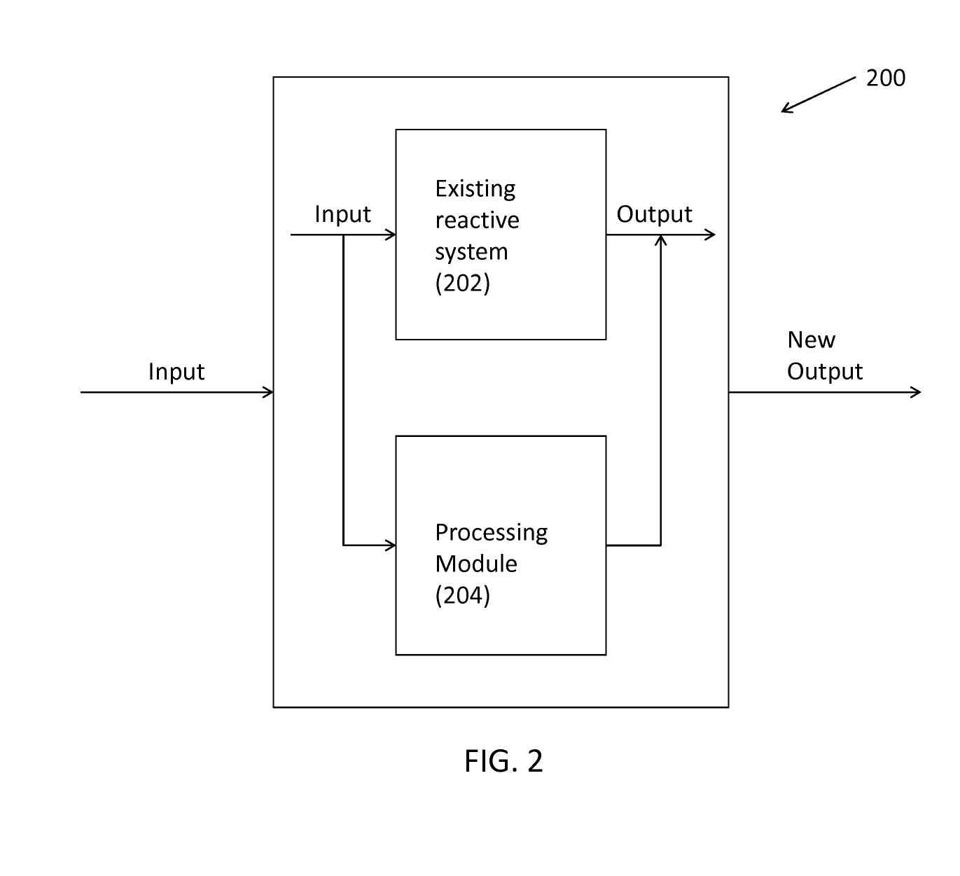

With reference to FIG. 2, there is shown an embodiment of the new reactive system 200 comprising: an existing reactive system 202 arranged to produce at least one output in response to at least one input applied to the new reactive system 200; a processing module 204 arranged to compare the at least one output with an expected output representative of an output expected to be obtained by applying the at least one input to the new reactive system 200, and to determining if the at least one output would be compatible with the expected output; wherein the compatibility between the at least one output and the expected output is used for generating a supervisory control rule set arranged for supervisory control of the existing reactive system 202 when used as part or whole of the new reactive system 200.

In this embodiment, the new reactive system 200 is implemented by including or reusing an existing reactive system 202 which may be originally designed for other applications or systems. Therefore such existing reactive system 202 may be partially not compatible with a new application or system which includes the new reactive system 200.

The new reactive system 200 is designed to fulfil a number of predefined requirements which may be expressed as one or more expected output representing an output expected to be obtained by applying certain inputs to the new reactive system 200. Such expected output may be partially different from the output produced by the existing reactive system 202 when the same input is applied to the existing reactive system 202.

In some example embodiments, the existing reactive system 202 and/or the new reactive system 200 is implemented as computer-executable instructions and the abovementioned software reuse method may be applied. Alternatively, one or more components of the new reactive system 200 including the existing reactive system 202 may be differently implemented, such as a programmable logic unit, a microcontroller, or any other suitable processing unit which may operate as part or whole of a reactive system.

Preferably, the processing module 204 is arranged to compare the output and the expected output so as to determine the compatibility between the expected output and the output produced by the existing reactive system 202. The determined compatibility may be used for indicating one or more input which is incompatible for the new reactive system 200. For example, a faulty or undesired output (which fails to match with the expected output) may be produced by the existing reactive system 202 in response to the applied incompatible input to the existing reactive system 202, or the existing reactive system 202 may execute one or more incompatible instructions in response to such incompatible input applied which may further cause an operation failure of the reactive system.

Due to a limitation that the existing reactive system 202 may be a black-box system which may prohibit a modification to the existing reactive system 202, it is not possible to modify internal processing pattern of the existing reactive system 202 associated with the inputs and the outputs. Therefore it is unavoidable that the existing produces faulty outputs when incompatible inputs are applied to the new reactive system 200 and hence the existing reactive system 202.

For example, the black-box system 202 may be implemented with instructions or source codes which are unknown to a developer of a new reactive system 200, and the modification to these internal instructions or source codes is not possible. It is desirable to prevent the produced incompatible or faulty output from being produced as a new output of the new reactive system 200.

Preferably, the determined compatibility may be further used for generating a supervisory control rule set arranged for supervisory control of the existing reactive system 202. For example, the supervisory control may be arranged to modify the predefined processing pattern with the supervisory control rule set to a modified processing pattern for use in the new reactive system 200, such that the new reactive system 200 may only produces desired and/or correct output in response to one or more applied input based on the modified processing pattern. Preferably, the supervisory control is implemented as a computer-executable program.

For example, the supervisory control may be arranged to modify the predefined processing pattern to the modified processing pattern whereupon the reactive system receives an incompatible input. This may include preventing a incompatible input from being processed by the existing reactive system 202 such that the existing reactive system 202 does not produce a faulty output, or preventing an incompatible output from being produced by the new reactive system 200 when such incompatible output is produced by the existing reactive system 202 in response to the applied incompatible input to the new reactive system 200.

In an example embodiment, the processing module 204 is arranged to perform a test (such as a learning-based test) so as to compare the output produced by the existing reactive system 202 and the expected output and to determine the compatibility between the outputs with a number of steps described as follows:

### A. Deterministic Finite Automaton

A deterministic finite automaton, denoted by A, is a quintuple A=(Q,Σ,δ,q₀,Qₘ),

where:
Q is the set of states;
Σ is the finite set of events associated with A;
δ:Q×Σ→Q is the transition function: δ(q, σ)=q₀ means that there is a transition labelled by event σεΣ from state qεQ to state q₀εQ. In general, δ is either a full function or a partial function on its domain;
q₀εQ is the initial state;
Qₘ⊂Q is the set of marked states; and
Σ* is the set of all finite strings of elements of Σ, including the empty string ε.
   For convenience, δ is extended from domain Q×Σ to domain Q×Σ* in the following recursive manner: δ(q,ε)=q, and δ(q,sσ)=δ(δ(q,s),σ), for qεQ, sεΣ* and σεΣ. Note that by default, the word automaton refers to DFA in an example embodiment.

The language generated by automaton A is:

[symbol]

={sεΣ*|ε(q₀) is defined}.

The language marked by automaton A is:

[symbol]

ₘ(A)={sε [symbol] (A)|δ(q₀,s)εQₘ}.

[symbol] (A) is the generated language of A, while [symbol] ₘ(A) is its marked language. The prefix closure of language [symbol] is the language, denoted by [symbol] consisting of all the prefixes of all the strings in [symbol] . Formally, [symbol] ={sεΣ*|(∃tεΣ)[stε [symbol] ]} is obtained.

### B. Supervisory Control Theory

Supervisory control theory (SCT) is a branch of systems control theory concerning the logical behavior of discrete-event systems (DES). Assume a DES, namely a plant, modeled by an automaton G with an event set Σ. The specifications that the plant must satisfy are specified as an automaton ii that has the same event set as G. The premise is that the behavior of G may not act as the specifications and must be modified through feedback control. In order to alter the behavior of G, a supervisory controller is introduced, which is denoted by an automaton V. The function of the supervisor V is to restrict the behavior of the plant model G to a proper subset of [symbol] ₘ(G) that satisfies the specifications [symbol] (H). It is desirable to adjoin a supervisor V interacting with G in a feedback manner to meet the specification model.

Let Σ be partitioned into two disjoint subsets Σ_{c} and Σᵤ, where Σ=Σ_{c}∪Σᵤ. Σ_{c} is the set of controllable events: the events can be prevented from happening or disabled by the supervisor V. Σᵤ is the set of uncontrollable events: the events cannot be prevented from happening or disabled by the supervisor V. The transition function of G can be controlled by V in the sense that the controllable events of G can be dynamically disabled by V. Γ={γε2^{Σ}|Σᵤ⊂γ⊂Σ} is the set of control patterns, each of which is a set of events allowed to occur. Formally, a supervisor control for G is a mapping V: [symbol] (G)→Γ. The pair (G,V) can be written as V/G, suggesting “G under the supervision of V”. Assume K⊂Σ*. Let KΣᵤ denote the set of strings of the form sσᵤ with sεK and σᵤεΣᵤ. Then a language KεΣ^{s} is controllable with respect to G if and only if K̅Σᵤ∩ [symbol] (G) ⊂K̅. The set of all sublanguages [symbol] (E) of the specification language E− [symbol] (H) that is controllable with respect to G is:

[symbol]

={K⊂|K is controllable with respect to G}.

The supremal element of [symbol] (E) is sup [symbol] (E)=∪{K|Kε [symbol] (E)}, which denotes the maximally permissive supervisor for G.

### C. Propositional Linear Temporal Logic

In an example embodiment, the learning-based test further comprises the step of receiving at least one requirement associated with the at least one input and the expected output, wherein the at least one requirement is expressed using Propositional Linear Temporal Logic.

Propositional linear temporal logic (PLTL) is a logical formalism specifying linear temporal properties of reactive systems. PLTL formulae over the set AP of atomic propositions are formed according to the following grammar:

φ::=true|αφ₁ [symbol] φ₂|: [symbol] φ|φ₁∪φ₂,

where αεAP and both φ₁ and φ₂ are PLTL formulas. The full power of propositional logic is obtained by using the boolean connectives [symbol] and [symbol] , ◯ is the next operator, standing for the next state. The until operator u allows to derive the temporal modalities ⋄ and □, where ⋄ means eventually (or in the future) and □ has the meaning of always (from now on forever). ⋄φ=true∪φ, while □φ= [symbol] ⋄ [symbol] φ.

### D. Learning-Based Testing

The basic idea of learning-based testing (LBT) is to automatically generate a large number of high-quality test cases by combing a model checking algorithm with an incremental model learning algorithm. The two algorithms are applied to the system under test (SUT) in iterative feedback loops which optimize test cases construction based on previous test outcomes. Test verdicts are test results indicating whether the tests are passed or not. LBTest is a practical tool for LBT of reactive systems. For reactive systems software testing, it is conventional to assume that an SUT can be adequately modeled by an automaton model. By using test cases as queries, it is possible to construct a logical hypothesis model for a black-box reactive system without a priori model.

An important assumption of automata learning algorithms is that the SUT is deterministic in its behavior. Furthermore, an automaton learning algorithm may only be guaranteed to terminate if the input and output events sets are finite. When an SUT involves infinite data types such as integer or floating point types, they must be finitely approximated using appropriate representative values. In an example embodiment, LBTest requires four data components:

1) a black-box reactive system under testing S;

2) a PLTL requirements set R;

3) a constructed hypothesis model M for S;

4) a verdicts set VE indicating whether the requirements are satisfied or not.

In the above four data components, 1) and 2) are basic input data, whereas 3) and 4) are output data. Preferably, a constructed hypothesis model for the existing reactive system 202 is obtained as a testing result of LBT, and the compatibility between the at least one output and the expected output of the new reactive system 200 is represented by a verdicts set arranged to indicate whether the at least one requirement are satisfied. If both the input data are available, one can use LBTest properly.

In an example embodiment, LBT and SCT may be integrated for the implementation of a new reactive system 200 which includes the existing reactive system 202. Before integrating an existing software component, the developer must test whether the component meets all system requirements. If the component violates any requirement, it must be modified if possible. In real applications, however, the source code and development models of the reused component are often unavailable. Then the problematic component has to be abandoned and the developer must develop a new software component. The development process thus cannot enjoy the benefit of software reuse. In order to enjoy the benefit of software reuse, the present invention provides a remedy for the failed component. The “fault prevention” remedy can monitor the reactive system behavior and prevents it from reaching faulty states.

For the application of SCT, an automaton model for a plant is essential. However, the logical model of a black-box reactive system is unavailable. In an embodiment of the invention, it is achieved by introducing an automata learning algorithm, which infers an automaton model for the black-box reactive system on the basis of all available input and output data. Using LBTest, a logical automaton model for the reactive system can be constructed automatically. The user requirements are written in PLTL, which can be checked in LBTest using model checker μSMV. Simultaneously, a plenty of test cases are generated, which are used for requirements test. When LBTest finishes the testing, verdicts for each requirement are given. If the system does not pass the test, counter examples are given. Advantageously, an online fault prevention program may be used to avoid the fault sequences, rather than completely abandon the reused software or existing reactive system 202.

The automaton model constructed by LBTest is employed as a logical model of the system. The requirements are described by another automaton. A supervisor for the system model restricted to the requirements is computed using SCT. By adjoining the supervisor, it will be possible to vary the language generated by the plant model within certain limits. The whole behavior of system is governed. Then the supervisor is transformed to an executable program. This control program is patched to the reused component to monitor the system behavior and govern it to act as user requirements.

In one example embodiment, the method for implementing a new reactive system 200 may comprise procedures as follows. Firstly, a learning-based testing technique is employed to thoroughly test the reactive system against design requirements. At the same time, a plenty of hypothesis automaton models for the reactive system are built iteratively according to the relationship of input and output trajectories. If the system passes the test, the reused software component satisfies the development requirements; otherwise, the reused software component fails the requirements. In the latter case, supervisory control theory is subsequently applicable to produce a supervisor for the constructed automaton of the system. Then the supervisor is transformed to an executable program to control the given black-box reactive system 202. Finally, in order to assure the satisfiability of user requirements, the system under control, including the reused software reactive system, and the added executable program for the supervisor, is tested again by LBTest to confirm the satisfaction to the requirements.

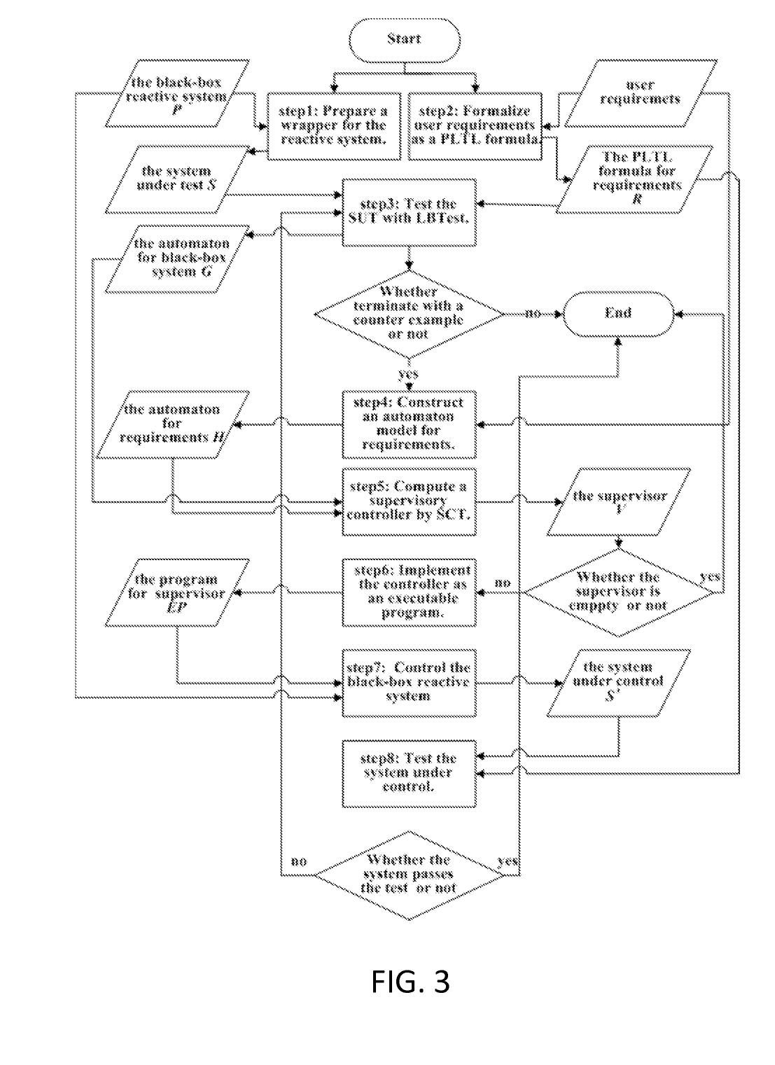

With reference to FIG. 3, there is shown the method for implementing a new reactive system 200 in accordance with one embodiment of the present invention is shown, which is further elaborated in the next paragraph from Step 1 to Step 8 in detail. In this flow diagram, rectangular boxes represent processing processes, while parallelograms are input and output data. The diamond is condition judgment, and rounded rectangles stand for the start and end.

### Step 1:

Prepare a wrapper for the reactive system.

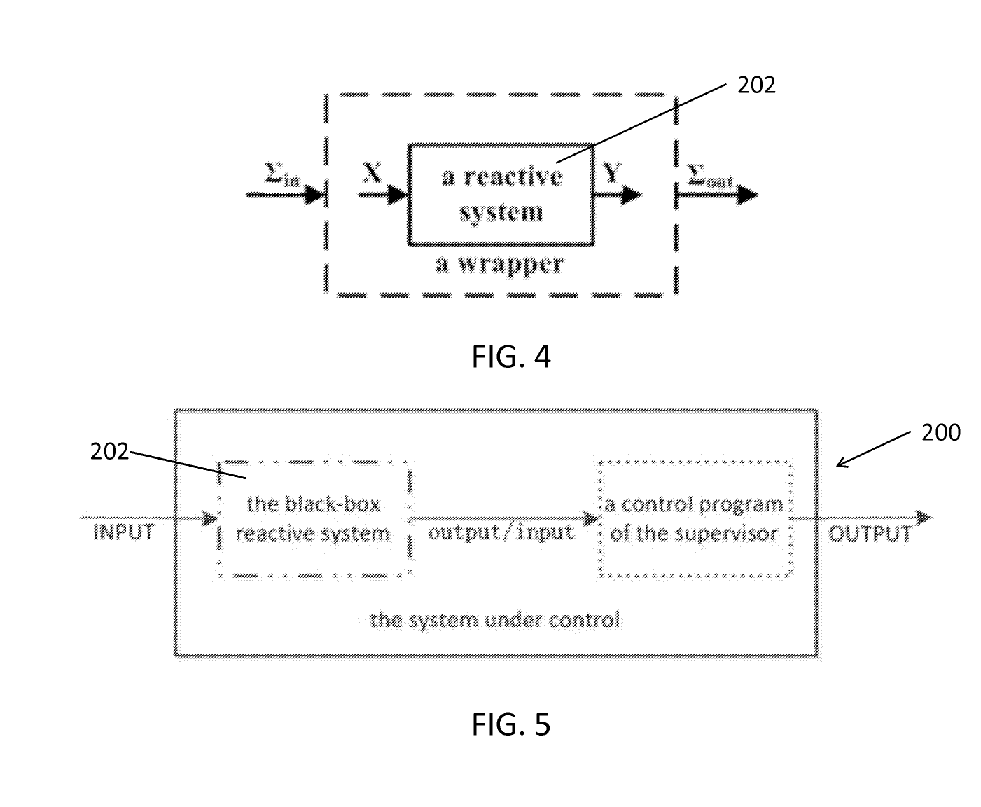

First of all, with reference to FIG. 4, a wrapper W may be written for the black-box reactive system 202, such that it can be used as a bridge between LBTest and P. The role of W for P is described in FIG. 4. When P involves infinite data types, both the input data and output data must be finitely approximated using other appropriate discrete values in W, which can be denoted by events set Σᵢₙ and Σₒᵤₜ, denoting the input and output event sets involved in the system test, respectively. The conversion of the input and output data between LBTest and P are implemented by the wrapper. Let X and Y be the input and output data sets of P, respectively. Σᵢₙ and Σₒᵤₜ are finite sets, while X and Y are either finite or infinite sets. Actually, a wrapper W acts as two functions fᵢₙ and fₒᵤₜ, where fᵢₙ is an conversion function for input data, while fₒᵤₜ is a one for output data between LBTest and P.

### Definition 1:

fᵢₙ: Σᵢₙ→X is a function with domain Σᵢₙ and codomain X. fᵢₙ(σ)={x|xεX}, where σεΣᵢₙ. fᵢₙ is an injective function.

### Definition 2:

fₒᵤₜ(y)={q|qεPwr(Σₒᵤₜ)}, where yεY and Pwr(Σₒᵤₜ) is the power set of Σₒᵤₜ. fₒᵤₜ:Y→Pwr(Σₒᵤₜ) is a function with domain Y and codomain Pwr(Σₒᵤₜ). fₒᵤₜ is an injective and many to one function.

The larger Σᵢₙ is, the more realistic the system is simulated. The finer Y is partitioned, the more precise the model is. The combination of P and W can be seen as an SUT S, which is one of the input data of LBTest. When P involves infinite data types, both the input data and output data must be finitely approximated using other appropriate discrete values in W, which can be denoted by events set Σᵢₙ and Σₒᵤₜ, respectively. W can be written in Java. Then S is produced in the form of a .jar file.

### Step 2:

Formalize user requirements as a PLTL formula.

At the very beginning, user requirements may be given in natural languages. An atomic proposition set AP must be derived according to Σᵢₙ and Σₒᵤₜ. In real applications, an input event in Σᵢₙ is either controllable or uncontrollable. Assume Σᵢₙ=Σᵢₙ_{ₙ}∪Σᵢₙ_{ᵤ}, where Σᵢₙ_{ₙ} and Σᵢₙ_{ᵤ} are two disjoint subsets of Σᵢₙ. Σᵢₙ_{ₙ} consists of all controllable events, while Σᵢₙ_{ᵤ} is an uncontrollable events set. User requirements are formalized by a PLTL formula denoted by R.

### Step 3:

Test the SUT with LBTest.

Both S and P are loaded into LBTest. A hypothesis automaton model G for S associated with R is produced. When S is sufficiently small to be fully learned, LBT is a sound and complete method to detect errors. However, for S of an industrial size, the use of incremental learning algorithms is essential to achieve scalable testing. Meanwhile, a series of test cases are generated. In this procedure, the satisfiability of R is tested effectively. A verdict V E ε{‘Pass’, ‘Warnings’, ‘Failed’} is produced. If VE=‘Pass’, the verification process terminates. Otherwise, turn to Step 4.

### Step 4:

Construct an automaton model for user requirements.

According to SCT, specifications may be specified as an automaton. Then a supervisor V can be computed to govern the plant to meet. Assume E= [symbol] (H).

### Step 5:

Compute a Supervisory Controller for G by SCT.

### Proposition 1:

G can be used as a plant model.

### Proof:

There are two kinds of automata learning algorithms used in LBTest: complete learning such as L* and incremental learning such as IKL. The output automata for both algorithms are DFAs, which are generators of formal languages. Thus, G can be used as a plant model.

### Proposition 2:

An automaton which is behavioral equivalence to the system can be constructed.

### Proof:

If a complete learning algorithm such as Ls is used in LBTest, a complete model that is behavior equivalent to the system is constructed. If an incremental learning algorithm such as IKL is used in LBTest, a series of hypothesis models M₁, M₂, . . . , Mₗ are generated. This sequence M₁, M₂, . . . , Mₗ will finitely converge to an behavioral equivalent model M for P, when the test cases are sufficiently large. So, a behavioral equivalence model for the system can always be constructed.

A maximally permissive supervisor for G restricted to H is computed using SCT. Control actions can be derived from the supervisors. There are also some tools for SCT computation (TCT, DESUMA, Supremica, etc.), which may be used to compute a supervisor automatically. Then, a supervisory V for G is built. If [symbol] (V)=Ø, G is restricted too strictly to follow the behavior of the requirements. Otherwise, turn to Step 6.

### Step 6:

Implement the supervisor as an executable program.

According to the control actions of the supervisor V, an executable program EP such as a Java program is derived. The program monitors the behavior of P and prevents it from entering “faulty program section”.

### Step 7:

Program control for the black-box system.

By monitoring the behavior of the system, EP enforces the black-box reactive system P to follow the behavior of the requirement R. With reference to FIG. 5, the method of the program control for a black-box reactive system 202 in accordance with an embodiment is shown, where the box with two points lines is the uncontrolled system P, while the box with solid lines outer is the system under control S′, which is seen as a new black-box system. The control program is a white-box system, which is drawn with dotted lines. ‘INPUT’ is external input data. ‘output’ is the output data of S, which is seen as the input data of the control program EP. EP monitors ‘INPUT’ and ‘output’ data, and produces ‘OUTPUT’ data, which satisfies user requirement R. Then, the output data of V denoted by ‘OUTPUT’ is obtained, which satisfies user requirements R.

### Step 8:

Test the complete system under control.

Optionally, the learning-based test may be repeatedly applied against the new reactive system 200 with the supervisory control to determine if at least one new output produced by the new reactive system 200 would be compatible with the expected output; and the supervisory control rule set further modified based on a compatibility between the at least one new output and the expected output.

The SUT derived in Step 7 is regarded as a new system. It is tested again in LBTest according to Step 1 to Step 3 to assure the satisfiability for R. Then the whole work for the proposed method terminates. Otherwise, turn to Step 3 to construct a more realistic model for P by prolonging a longer learning time. If P is a large system, a longer learning time should be set in LBTest to produce a more precise model as far as possible.

### Proposition 3:

The method can terminate.

### Proof:

If G is a behavioral equivalence model for P, whether [symbol] (V)=Ø or not the proposed method can terminate according to the above discussion. If S′ does not pass the test, a new model for P can be constructed in LBTest by setting a longer learning time. Then turn to Step 4. According to Proposition 2, an automaton which is behavioral equivalence to the system can be constructed in finite time as long as the input and output data sets are sufficiently large. Then the proposed method terminates.

From Step 1 to Step 3, LBT is used for system requirements testing and hypothesis automaton model constructing of the black-box reactive system 202. From Step 4 to Step 5, SCT is used to compute a supervisor for the system model. From Step 6 to Step 7, the supervisor is transformed to an executable program to govern the black-box reactive system 202 to follow the behavior of user requirements. In the final step, the system under control is tested to assure the satisfiability of user requirements. In conclusion, the proposed method enlarges the application domain of SCT to control black-box reactive system 202. And a component may be reused even if it does not satisfy user requirements at first.

These embodiments are advantages in that the method discussed adds a “fault prevention” component that monitors the reactive system behavior and prevents it from reaching faulty sections by integrating learning-based testing and supervisory control of discrete-event systems. The method is effective as long as the input and corresponding output data of reactive systems are observable.

Advantageously, the method iteratively builds automaton models of the reactive system according to the relationship of input and output trajectories of the system. Such that the constructed automata models are used to generate high efficiency test cases to reach high test coverage percentage. If the system under test does not satisfy user requirements, SCT is subsequently applied to produce a supervisor for the constructed model of the system.

The supervisor may be transformed to an executable program to monitor the behavior of the integrated system, including the reused reactive system and the control program. Therefore, the control program may prevent the black-box reactive system from reaching faulty program sections. In addition, in order to assure satisfiability of user requirements, the system under control may be tested again by LBTest to confirm the satisfaction for the requirements.

These embodiments are also advantageous in that the invention enable the application of supervisory control theory to complex systems without priori models. And the other is to improve the efficiency of the reactive system software reuse by correcting its faulty behavior online.

In one example embodiment, the method for implementing a new reactive system 200 may be used for implementing a cruise controller (CC) with a reused reactive system.

A CC is an embedded safety critical component commonly used in modern vehicles. Four data types in Σ={in, mode, speed, button} are involved in CC. Σᵢₙ={brake, dec, gas, acc, switch} is input event set. The symbolic inputs brake and gas are used to denote deceleration and acceleration events issued by the vehicle driver, while the input events dec and acc denote deceleration and acceleration from the external environment due to physical factors such as moving uphill or downhill, respectively. The symbolic input switch is used to turn on or turn off the CC button.

Table I shows the symbolic values of the input data type (column one) and their encodings (column two) of events. For simplicity, the input data is expressed as Σᵢₙ={d, d, g, a, s}. These symbolic values and encodings may be entered into LBTest (for example as a configuration file) by the user. Table II shows the symbolic values of all output data types for the CC. This table identifies three output types: mode, speed and button in the column one. The symbolic values taken by each data type are shown in the second column in Table II. They are manual, cruise and disengaged for the mode data type, and zero, one and two for the speed data type. The values of the button are on and off. In fact, the speed of a vehicle is a continuous value. In this example, we discretize the continuous speed into three partition classes coarsely, symbolically named zero, one and two. Intuitively one is an acceptable range of cruise speeds, while the other classes stand for too slow or too fast for cruising, respectively. For example, symbolic values are zero when 0.0≦speed<60.0, one when 60.0≦speed<120.0, and two when speed≧120.0.

TABLE I
Input data types for the CC

| Constant Symbol | Encoding |
|---|---|
| brake | b |
| dec | d |
| gas | g |
| acc | a |
| switch | s |

TABLE II
Output data types for CC

| Data Type | Symbolic Value |
|---|---|
| mode | manual |
| mode | cruise |
| mode | disengaged |
| speed | zero |
| speed | one |
| speed | two |
| button | on |
| button | off |

### 1) LBT for the CC:

First, a wrapper W for CC denoted by P is written using Java. The combination of P and W composes the SUT S. The user requirement is a safety property: if the mode of a vehicle is in manual and the speed is at two, even if the cruise button is in on, it cannot enter into the cruise mode. It means that if the speed is at two, it is too fast to cruise for a vehicle. The PLTL formula that describes this property is given as R:

□(mode=manual [symbol] button=of f [symbol] speed=two [symbol] input=switch→ [symbol] ◯(mode=cruise)).

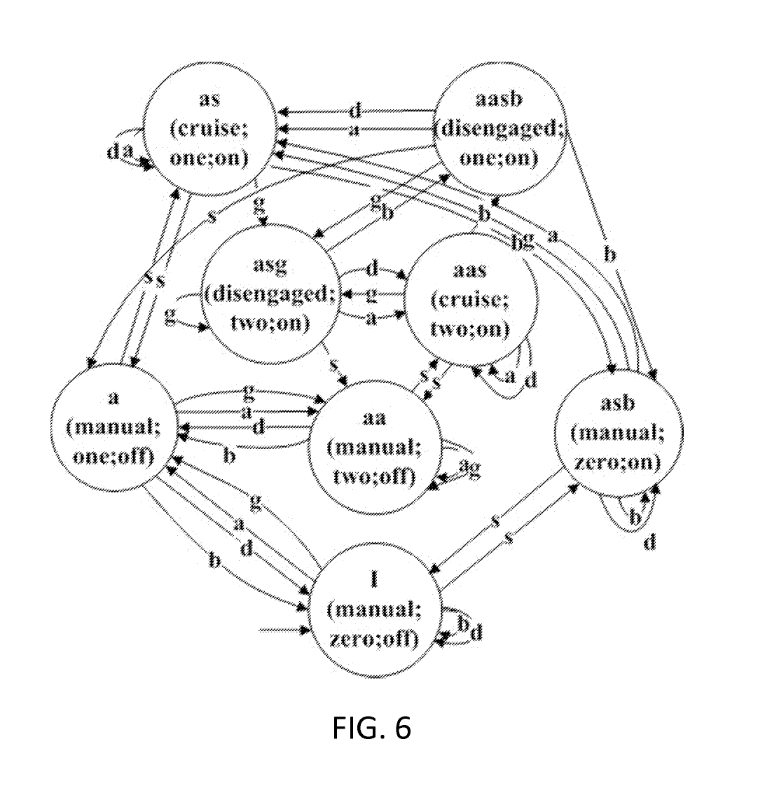

S and R are loaded into LBTest and perform the test. An automaton model G for the CC is constructed, as shown in FIG. 6. There are eight states and 40 transitions. The initial state ‘manual;zero;off’ stands for that the CC is in mannual mode with a zero speed and an off button status. The meaning of other states can be interpreted like the initial state does. If the event a or g occurs, the state transforms from the initial state to state ‘manual;one;off’. It means if the driver presses the gas pedal, or the road is downhill, the speed at zero will accelerate to one. Other transitions are explained as the same way. After the experiments, a verdict with a value ‘Warning’ (due to loops in FIG. 6) is given. It means that the requirement R is unsatisfied. One of the counter examples is the event sequence ‘acc, acc, switch, dec, dec, dec’, corresponding to the event sequence ‘aasddd’ from the initial state in FIG. 6. When the speed is at two, the vehicle enters the cruise mode, which violates R. By analyzing this counter example's trajectory, we find a faulty state ‘cruise;two;on’, which makes the behavior of CC violate requirement R. It demonstrates that even if the speed is at two, the vehicle is in the cruise mode now. However, since the source code of the CC is unknown to us, it is not able to modify its implementation to avoid this fault.

### 2) Supervisory Control Implementation for the CC:

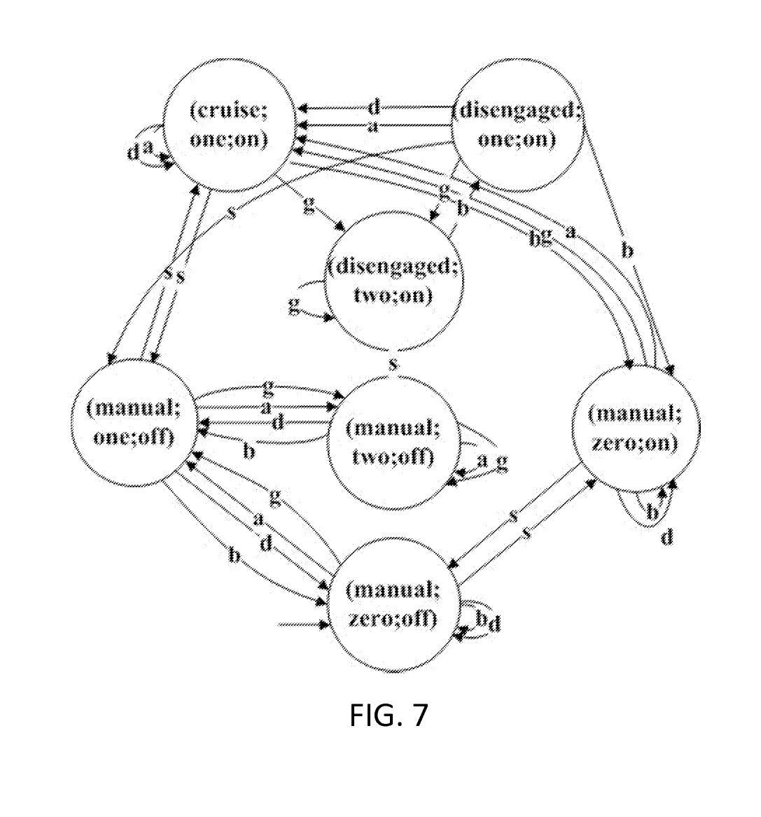

First, we build an automaton model for the requirement R. According to the explicit explanation of R and the hypothesis model G for the CC, we construct an automaton model for R, denoted by H, which is shown in FIG. 7. There are 32 transitions and seven states in H.

Each event in Σᵢₙ is either controllable or uncontrollable. Different supervisors are derived according to different controllable and uncontrollable event sets. In theory, there are 32 possible uncontrollable event subsets of Σᵢₙ. The corresponding controllable event subsets are their complement sets for Σᵢₙ. All the possible uncontrollable event subsets of Σᵢₙ are listed as an element in the following sets:

Σᵢₙ_{ᵤ₁}={Ø,{b},{g},{b,g}},

Σᵢₙ_{ᵤ₂}={{a},{d},{d,b},{a,b},{a,d},{a,b,d}},

Σᵢₙ_{ᵤ₃}={{s},{d,s},{s,b},{b,d,s}},

Σᵢₙ_{ᵤ₄}={{d,g},{a,g},{d,a,g},{a,b,g},{d,b,g},{b,g,d,a}},

Σᵢₙ_{ᵤ₅}={{a,s},{s,g},{a,d,s},{d,s,g},{a,s,b}{a,s,g},{s,b,g},{d,a,s,b},{d,s,b,g},{d,a,s,g},{a,s,b,g},{d,a,s,b,g}}.

Aiming at every element of these sets, a maximally permissive supervisor is computed by SCT. As a result, some supervisors for different uncontrollable event sets are the same. In order to simplify the results, we put those uncontrollable event sets which have the same supervisor in one set Σᵢₙ_{ᵤᵢ}, where iεI, and I={1,2,3,4,5} is an index set. There are five kinds of supervisors in total, denoted by Vᵢ, where iεI. For any [symbol] (Vₜ)=Ø, it is transformed to an executable program EPᵢ that is used to control the CC to follow the behavior of user requirement according to the method shown in FIG. 2. Then, the combination of EPᵢ and the CC is considered as a new SUT Sᵢ. In order to assure the satisfiability for R, Sᵢ is tested again in LBTest. Automaton models for the CC under control according to different controllability of events in Σᵢₙ are constructed, denoted by Gᵢ. The test results are ‘Pass’. For clarity, all the uncontrollable subsets, supervisors, executable programs, new SUTs and test results are listed in Table III.

TABLE III
Experimental results

| uncontrollable event set | Σᵢₙ_{ᵤ₁} | Σᵢₙ_{ᵤ₂} | Σᵢₙ_{ᵤ₃} | Σᵢₙ_{ᵤ₄} | Σᵢₙ_{ᵤ₅} |
|---|---|---|---|---|---|
| supervisor | V₁ | V₂ | V₃ | V₄ | ø |
| control program | EP₁ | EP₂ | EP₃ | EP₄ | — |
| new SUT | S₁ | S₂ | S₃ | S₄ | — |
| hypothesis model for new | G₁ | G₂ | G₃ | G₄ | — |
| verdict | Pass | Pass | Pass | Pass | — |

The transition function of Gᵢ is controlled by Vᵢ in the sense that the controllable events of G can be dynamically controlled by supervisor Vᵢ. The corresponding control actions of the computed supervisors are listed in Table IV.

TABLE IV
Control actions for different uncontrollable event sets

| uncontrollable | | | | | |
|---|---|---|---|---|---|
| event sets state | Σᵢₙ_{ᵤ₁} | Σᵢₙ_{ᵤ₂} | Σᵢₙ_{ᵤ₃} | Σᵢₙ_{ᵤ₄} | Σᵢₙ_{ᵤ₅} |
| (mannual; zero; off) | | | | s | d, a, s, b, g |
| (mannual; zero; on) | | | | | d, a, s, b, g |
| (cruise; one; on) | | g | g | s | d, a, s, b, g |
| (mannual; one; off) | | | a, g | s | d, a, s, b, g |
| (mannual; two; off) | s | s | | s | d, a, s, b, g |
| (disengaged; one; on) | | | | | d, a, s, b, g |
| (disengaged; two; on) | a, d | | | s | d, a, s, b, g |
| (cruise; two; on) | | | | s | d, a, s, b, g |

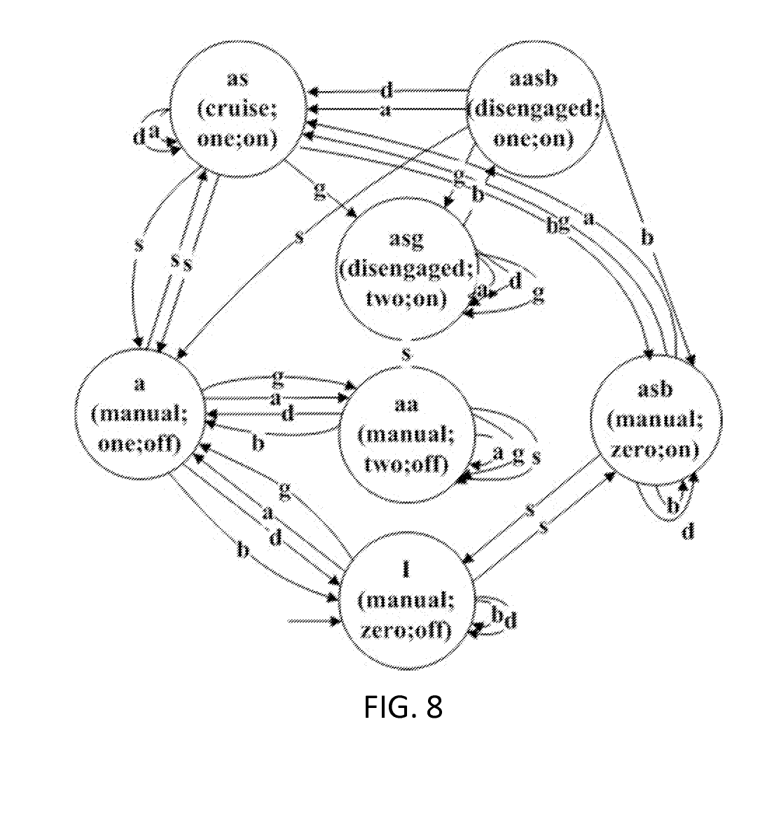

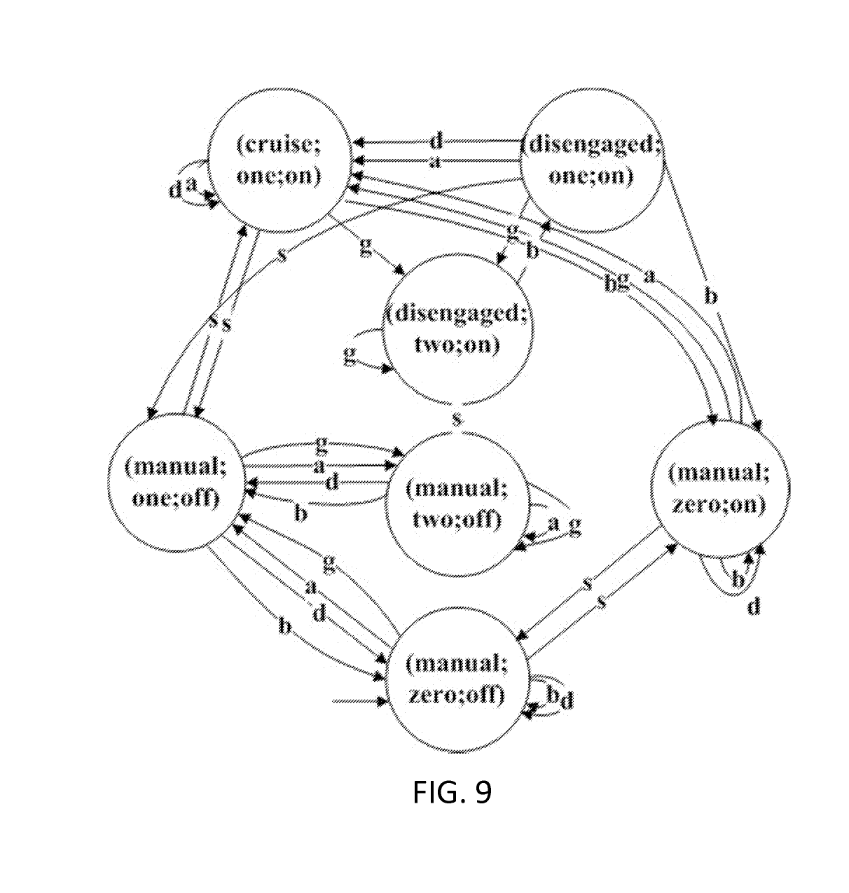

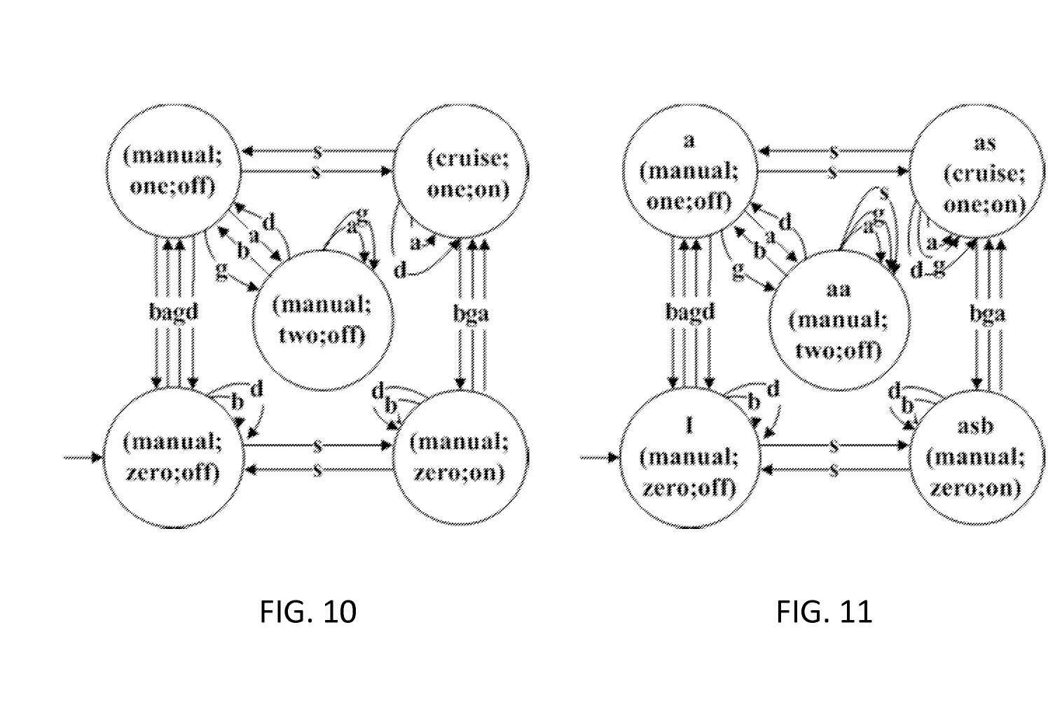

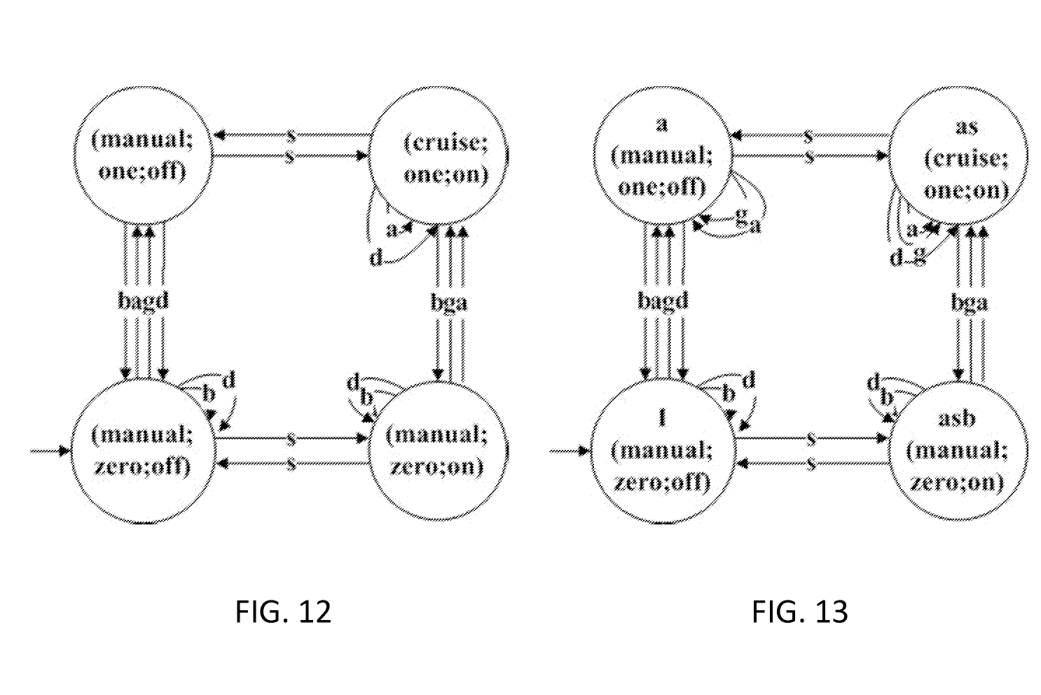

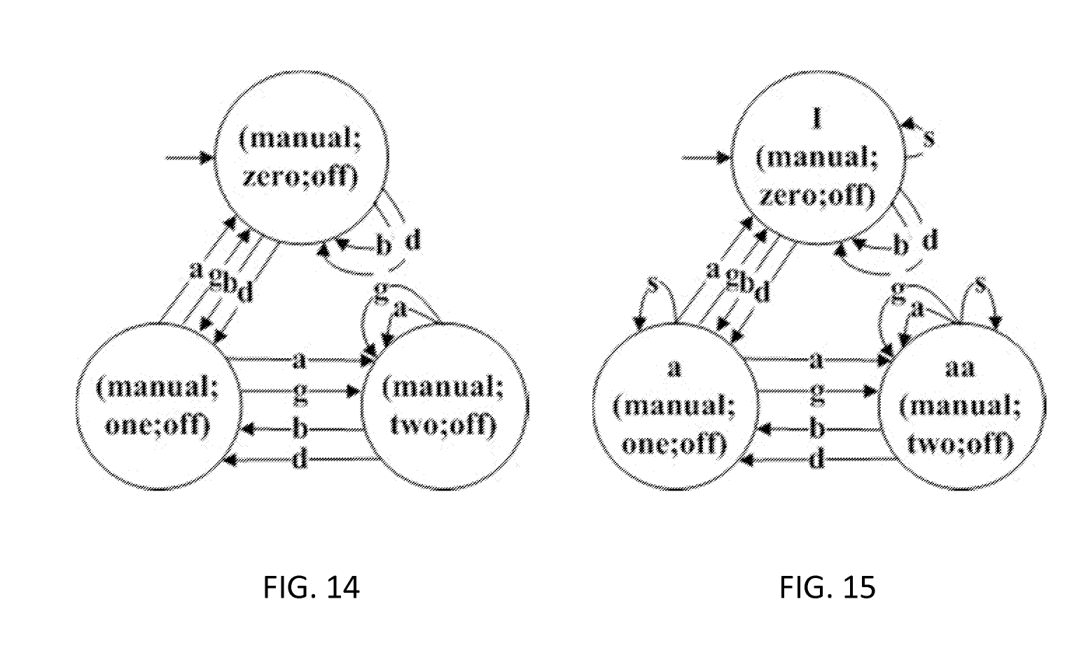

The supervisor V₁ for sets in Σᵢₙ_{ᵤ₁} is described in FIG. 8. From Table IV, we can see that the control actions of V₁ are that event s is disabled at state ‘manual;two;off’ and events a and d are disabled at state ‘disengaged;two;on’. Then V₁ is transformed to an executable java program EP₁ to control the CC. The CC under control is regarded as a new SUT S₁. Load S₁ and requirement R into LBTest, and experimental result shows that the verdict is ‘Pass’. This result shows that S₁ satisfies the requirement R. The constructed automaton model G₁ for S₁ is shown in FIG. 9. There are 35 transitions and seven states. There is no state ‘cruise;two;on’ in G₁ any more. Since event s emitted from ‘manual;two;off’ and events a and d emitted from ‘disengaged;two;on’ are disabled by EP₁. The supervisor V₂ for Σᵢₙ_{ᵤ₂} is shown in FIG. 10. The control actions are that event s is disabled at state ‘manual;two;off’ and events g is disabled at state ‘cruise;one;on’. The newly constructed hypothesis automaton model G₂ for S₂ is shown in FIG. 11. There are 25 transitions and five states. The supervisor V₃ for Σᵢₙ_{ᵤ₃} is obtained, as shown in FIG. 12. The control action is that events a and g are disabled at state ‘manual;one;off’ and event g is disabled at state ‘cruise;one;on’. The corresponding hypothesis automaton model for S₂ is shown in FIG. 13 denoted by G₂. There are 20 transitions and four states. The supervisory controller V₄ for Σᵢₙ_{ᵤ₄} is described in FIG. 14. The control actions are that event s is disabled at states ‘manual;zero;off’, ‘manual;one;off’ and ‘manual;two;off’. The newly constructed automaton model G₄ for system under control S₄ is shown in FIG. 15. There are 15 transitions and three states. The supervisor for Σᵢₙ_{ᵤ₄} is empty. In this situation, all the events are disabled in every state. All the control actions are used to help preventing the system from entering the ‘faulty’ state ‘cruise;two;on’. All the supervisors are transformed to executable Java programs to control the CC. Testing results show that all the systems under control follow the proper behavior of the requirement R.

3) An Example Supervisor Suggested:

In certain examples, both the event brake and gas may be mastered by drivers. Therefore, b and g are always uncontrollable for the CC internal control. In this situation, a feasible maximum permissive controller is suggested in FIG. 8. The control actions are that event s is disabled a state ‘manual;two;off’ and events a and d are disabled in state ‘disengaged;two;on’, which prevents the system from entering the state ‘cruise;two;on’. Then, the system under control satisfies the requirement K. Adjoining this control program to the CC, the integrated system, including the CC and EP₂, acts as the behavior of the specifications. For the sake of software reuse, the CC component is reused successfully.

In another example embodiment, the method for implementing a new reactive system 200 may be used for implementing a brake-by-wire (BBW) system with a reused reactive system.

A simulink model of BBW was developed by Volvo Technology AB and its corresponding Java code was developed. The BBW is composed of five electronic control units (ECUs). The central ECU is connected with a brake pedal and a gas pedal, while the other four ECUs are attached to four wheels. The software components on the central ECU run the sensor of the brake pedal, and calculate the global brake torque from the brake pedal position and distribute the global torque to the four wheels. The software components on each wheel ECU will measure the wheel speed, control the brake actuator and implement the ABS controller.

Two types of floating input data denoted by breakPedalPos and gasPedalPos are involved in BBW, which are received from the positions of the brake and gas pedals, respectively. The input data is mapped to the discrete input event set Σᵢₙ={brake, acc idle}, where brake and acc stand for a driver presses the brake pedal and gas pedal, respectively, while idle means no operation. There are three types of output values: vehSpeed denoting the vehicle speed, rotational speeds of the four wheels (front right, front left, rear right and rear left) denoted by ωSpeedFIR, ωSpeedFL, ωSpeedRP and ωSpeedRL, and the torque values on the four wheels denoted by torqueOnFR, torqueOnFL, torqueOnRR and torqueOnRL, respectively. The slipFR, slipFL, slipRR and slipRL stand for the slipping states of four wheels. The discrete formulas and the corresponding symbolic outputs values are shown in Table V. If vehSpeed>10 km/h, we assume that the vehicle is moving, otherwise, the vehicle is still. For simplicity, only the output values of the rear right wheel are listed as an example. If ωSpeedRR>0, the output value for WheelRoateRR is nonZero. If torqueOnRR>0, the output value for torqueOnRR is nonZero.

TABLE V
Output data types for BBW

| | | Symbolic |
|---|---|---|
| Data Type | Discrete Formula | Output Value |
| speed | vehSpeed ≦ 10 | still |
| speed | vehSpeed > 10 | moving |
| WheelRotateRR | ωSpeedRR > 0 | nonZero |
| torqueOnRR | torqueOnRR > 0 | nonZero |
| slipRR | 10 * (velSpeed − ωSpeedRR) > | slip |
| | 2 * velSpeed | |

### 1) LBT for the BBW:

The BBW is a hard real-time safety critical system. Feng, etc. specified three strict safety requirements and tested them using LBTest [28]. One of the requirements failed the test. In order to reuse the BBW system without changing the source code, the proposed method is applied to BBW.

For safety purposes, the ABS controller in the BBW system shall release the corresponding brake actuator when the slip rate of any wheel is larger than the threshold and the vehicle is moving at a speed of above certain values. The requirement which did not pass the test is: if the brake pedal is pressed and the actual speed of the vehicle is larger than 10 km/h and the slippage sensor shows that a wheel is slipping, the corresponding brake torque at the wheel should be zero. By taking the rear right wheel as an example, the corresponding PLTL formula is:

□(in=brake [symbol] specd=moving [symbol] slipRR=slip→◯(torqueRR=zero)).

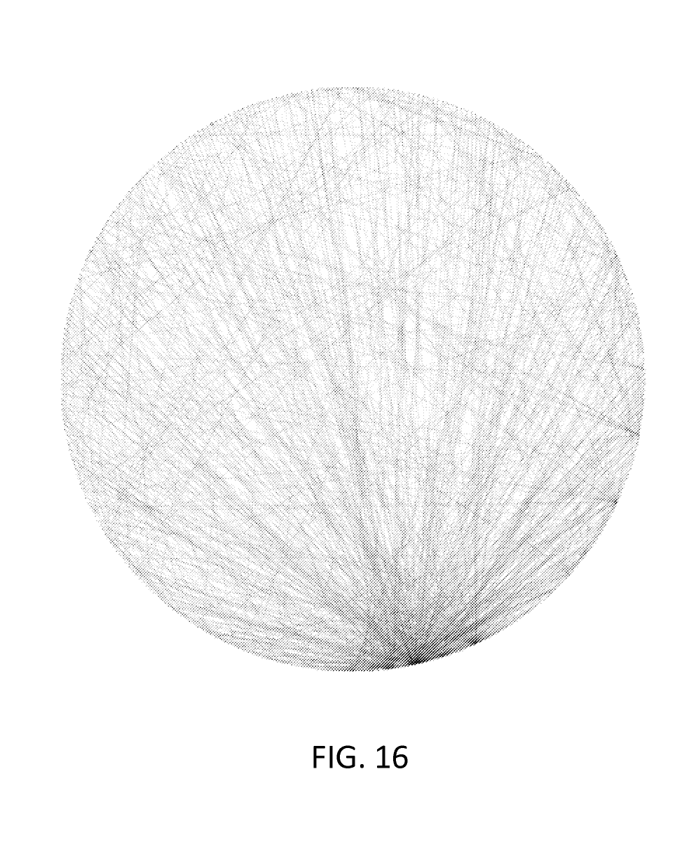

The test was repeated in LBTest, and many counter examples are given. One of them is the execution event trace ‘idle, acc, acc, acc, brake, brake, brake, brake, brake’. The corresponding state transition sequence is ‘(under1, still, zero, noSlip), (under1, still, zero, noSlip), (10, moving, zero, noSlip), (20, moving, zero, noSlip), (30, moving, zero, noSlip), (20, moving, zero, slip), (1, still, nonZero, slip), (under1, still, nonZero, noSlip), (under1, still, nonZero, noSlip), (under1, still, nonZero, noSlip)’. At state ‘(20, moving, zero, slip)’, when the driver presses the brake pedal, the torque value for next state should be zero, since the vehicle is moving and the rear right wheel is slipping. However, the behavior of the counter example shows that the torque value on that wheel is nonZero, which violates the requirement. A hypothesis automaton model for BBW with 360 states and 1080 transitions is constructed at the same time, as shown in FIG. 16.

### 2) Supervisory Control Implementation for the BBW:

In SCT, an automaton for specifications is needed. We construct the automaton model for the requirement according to the model in FIG. 16. There are 360 states and 1057 transitions. Since there are just two types of input events brake and acc, we assume that Σᵢₙ_{₀}={brake,acc}. A supervisor is computed in DESUMA, which has 329 states and 964 transitions. By analyzing the control actions in the supervisor, event brake emitted from the following states in FIG. 14 is disabled: (10,moving,zero,slip), (20,moving,zero,sup), (30,moving,zero,slip), (40,mov-ing,zero,slip), (60,moving,zero,slip) and (70,moving,zero,slip). A control program is written according to the control actions to prevent the system entering states ‘-,-,nonZero,-’, when the vehicle is moving, the wheel is slipping and the driver presses the brake pedal. By adjoining the control program to the BBW system, a new system is generated. Testing the controlled system for the requirement in LBTest, the test result is ‘Pass’. The sizes of all the automata used to control the BBW in our experiments are listed in Table VI. Above all, the method may be applied to an industrial size case to enable software components reuse.

TABLE VI
Experiment results for BBW

| | the hypothesis | the model | | the model for |
|---|---|---|---|---|
| experiment | model for | for speci- | the | BBW under |
| results | BBW | ficaiton | supervisor | control |
| state | 360 | 360 | 329 | 349 |
| numbers | | | | |
| transition | 1080 | 1057 | 964 | 1047 |
| numberrs | | | | |
| test results | Warnings | — | — | Pass |

In the above two example embodiments, the CC is a small pedagogical example, while the BBW is an industrial one. By adjoining a ‘fault prevention’ component to the system under control, the proposed method is successfully used to enable the software reuse in the case of some requirements are not satisfied. Both the systems under control are tested again in LBTest, and the ‘Pass’ results show that the systems are well controlled, which reinforce the feasibility of the proposed method.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that the term “database” may include any form of organized or unorganized data storage devices implemented in either software, hardware or a combination of both which are able to implement the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A method for implementing a new reactive system comprising the steps of:
applying at least one input suitable for the new reactive system to an existing reactive system to obtain at least one output produced by the existing reactive system;
comparing the at least one output with an expected output representative of an output expected to be obtained by applying the at least one input to the new reactive system;
determining if the at least one output would be compatible with the expected output; and
using the compatibility between the at least one output and the expected output to generate a supervisory control rule set arranged for supervisory control of the existing reactive system when used as part or whole of the new reactive system.

2. A method for implementing a new reactive system in accordance with claim 1, wherein the supervisory control is arranged to modify a predefined processing pattern of the existing reactive system with the supervisory control rule set to a modified processing pattern for use in the new reactive system.

3. A method for implementing a new reactive system in accordance with claim 2, wherein the existing reactive system is arranged to process the at least one input to produce the at least one output based on the predefined processing pattern.

4. A method for implementing a new reactive system in accordance with claim 1, wherein the existing reactive system is a black-box system.

5. A method for implementing a new reactive system in accordance with claim 4, wherein a modification to the existing reactive system is prohibited.

6. A method for implementing a new reactive system in accordance with claim 2, further comprising the step of indicating at least one incompatible input to the new reactive system whereupon a determination of an incompatibility between the at least one output produced by the existing reactive system and the expected output.

7. A method for implementing a new reactive system in accordance with claim 6, wherein the supervisory control is arranged to modify the predefined processing pattern to the modified processing pattern whereupon the reactive system receives an incompatible input.

8. A method for implementing a new reactive system in accordance with claim 7, wherein the supervisory control is arranged to prevent the at least one incompatible input from being processed by the existing reactive system.

9. A method for implementing a new reactive system in accordance with claim 7, wherein the supervisory control is arranged to prevent an incompatible output from being produced by the new reactive system.

10. A method for implementing a new reactive system in accordance with claim 1, wherein the supervisory control is arranged to prevent an execution of an instruction being incompatible to the existing reactive system.

11. A method for implementing a new reactive system in accordance with claim 1, wherein the steps of comparing the at least one output with an expected output representative of an output expected to be obtained by applying the at least one input to the new reactive system and determining if the at least one output would be compatible with the expected output are steps of a learning-based test.

12. A method for implementing a new reactive system in accordance with claim 11, wherein the learning-based test further comprises the step of receiving at least one requirement associated with the at least one input and the expected output, wherein the at least one requirement is expressed using Propositional Linear Temporal Logic.

13. A method for implementing a new reactive system in accordance with claim 12, wherein the learning-based test further comprises the step of obtaining a constructed hypothesis model for the existing reactive system.

14. A method for implementing a new reactive system in accordance with claim 13, wherein the compatibility between the at least one output and the expected output of the new reactive system is represented by a verdicts set arranged to indicate whether the at least one requirement are satisfied.

15. A method for implementing a new reactive system in accordance with claim 11, further comprising the steps of:
repeating the learning-based test against the new reactive system with the supervisory control to determine if at least one new output produced by the new reactive system would be compatible with the expected output; and
modifying the supervisory control rule set based on a compatibility between the at least one new output and the expected output.

16. A new reactive system comprising:
an existing reactive system arranged to produce at least one output in response to at least one input applied to the new reactive system;
a processing module arranged to compare the at least one output with an expected output representative of an output expected to be obtained by applying the at least one input to the new reactive system, and to determine if the at least one output would be compatible with the expected output;
wherein the compatibility between the at least one output and the expected output is used for generating a supervisory control rule set arranged for supervisory control of the existing reactive system when used as part or whole of the new reactive system.

17. A new reactive system in accordance with claim 16, wherein the supervisory control is arranged to modify a predefined processing pattern of the existing reactive system with the supervisory control rule set to a modified processing pattern for use in the new reactive system.

18. A new reactive system in accordance with claim 17, wherein the existing reactive system is arranged to process the at least one input to produce the at least one output based on the predefined processing pattern.

19. A new reactive system in accordance with claim 18, wherein the existing reactive system is a black-box system.

20. A new reactive system in accordance with claim 19, wherein a modification to the existing reactive system is prohibited.

21. A new reactive system in accordance with claim 17, wherein the processing module is further arranged to indicate at least one incompatible input to the new reactive system whereupon a determination of an incompatibility between the at least one output produced by the existing reactive system and the expected output.

22. A new reactive system in accordance with claim 21, wherein the supervisory control is arranged to modify the predefined processing pattern to the modified processing pattern whereupon the reactive system receives an incompatible input.

23. A new reactive system in accordance with claim 22, wherein the supervisory control is arranged to prevent the at least one incompatible input from being processed by the existing reactive system.

24. A new reactive system in accordance with claim 22, wherein the supervisory control is arranged to prevent an incompatible output from being produced by the new reactive system.

25. A new reactive system in accordance with claim 16, wherein the supervisory control is arranged to prevent an execution of an instruction being incompatible to the existing reactive system.

26. A new reactive system in accordance with claim 16, wherein the processing module is arranged to employ a learning-based test to the new reactive system so as to determine the compatibility between the at least one output and the expected output.

27. A new reactive system in accordance with claim 26, wherein the processing module is further arranged to receive at least one requirement associated with the at least one input and the expected output, wherein the at least one requirement is expressed using Propositional Linear Temporal Logic.

28. A new reactive system in accordance with claim 27, wherein the processing module is further arranged to obtain a constructed hypothesis model for the existing reactive system.

29. A new reactive system in accordance with claim 28, wherein the compatibility between the at least one output and the expected output of the new reactive system is represented by a verdicts set arranged to indicate whether the at least one requirement are satisfied.

30. A new reactive system in accordance with claim 26, wherein the processing module is further arranged to repeat learning-based test against the new reactive system with the supervisory control to determine if at least one new output produced by the new reactive system would be compatible with the expected output, wherein the supervisory control rule set is modified based on a compatibility between the at least one new output and the expected output.
